(19) United States
(12) Patent Application Publication
(10) Pub. No.: US 2004/0205460 A1
(43) Pub. Date: Oct. 14, 2004

(54) Notepad for web browser

(75) Inventor: Prabhakar Gopalan, Austin, TX (US)

Correspondence Address: Frank C. Nicholas, CARDINAL LAW GROUP, Suite 2000, 1603 Orrington Avenue, Evanston, IL, 60201, US

(73) Assignee: IBM Corporation, Armonk, NY

(21) Appl. No.: 10/007,063

(22) Filed: Nov. 8, 2001

(51) Int. Cl. G06F 15/00; G06F 17/24

(52) U.S. Cl. 715/500; 715/501.1

(57) ABSTRACT

The invention provides a method of saving selected portions of a Web page to a client local storage. A user will select a portion of a Web page. The selected text data, image data, and site link data will be stored to the client local storage. The relevant date information will be determined from the Web browser. This date information will be linked to the stored portion of the Web page.

### FIELD OF THE INVENTION

The present invention relates generally to a technique for copying portions of a Web page locally to facilitate quick and efficient access to only relevant portions of Web pages.

### BACKGROUND OF THE INVENTION

When we surf the Web we may come across portions of Web pages that we would like to refer to later. Currently, to save a reference to this information or to more quickly access the Web page again we have only a couple of options. One thing we can do is to create a bookmark to store the Web page's URL in the Web browser. The other option is to save the entire contents of the Web page as a file.

Creating a bookmark to a Web page may seem convenient, but nowadays Web pages are rather lengthy with extensive graphics and therefore take a significant amount of time to load. When you only wish to refer to a small portion of this Web page, the bookmark option may seem tedious and time-consuming.

Saving the entire contents of the Web page as a file may also seem convenient, but, depending on the memory of your machine, you might not have enough space to save all of the Web pages that you find interesting.

A need has emerged to locally store only the relevant portions of the Web pages that we would like to later refer. By storing only the portions of the Web pages that we want to refer to later we will save needed memory on our client machine and will also save time in accessing this information.

### SUMMARY OF THE INVENTION

One aspect of the present invention is a method of saving selected portions of a Web page to a client local storage. A user will select a portion of a Web page. The selected text data, image data, and site link data will be stored to the client local storage. The relevant date information will be determined from the Web browser. This date information will be linked to the stored portion of the Web page.

Another aspect of the present invention is a computer usable medium storing a program for receiving a selection of a portion of a Web page; storing the selected portion of the Web page to the client local storage; determining the date information from a Web browser; and linking the date information to the stored portion of the Web page.

Another aspect of the present invention is a system for saving selected portions of a Web page to a client local storage comprising means for receiving a selection of a portion of the Web page; storing the selected portion of the Web page to the client local storage; determining the date information from a Web browser; and linking the date information to the stored portion of the Web page.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a block diagram illustrating one embodiment of a system for saving selected portions of a Web page to a client local storage in accordance with the present invention; and

FIG. 2 is a flow chart illustrating one embodiment of a method for saving selected portions of a Web page to a client local storage in accordance with the present invention.

### DETAILED DESCRIPTION OF THE PRESENTLY PREFERRED EMBODIMENTS

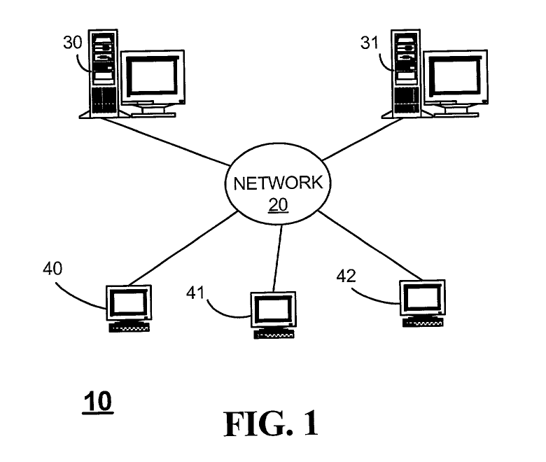

Referring to FIG. 1, one embodiment of a system for saving selected portions of a Web page to a client local storage is generally shown at numeral 10. In this example, the shown system is a general network comprising clients and servers. This network, 20, may provide communication links between various devices and computers connected together within this environment. Network 20 may include permanent connections, such as wire or fiber optic cables, or temporary connections made through telephone or wireless communications.

In the example shown, servers 30 and 31 may be used for running Web servers that enable clients to connect to the Web. Clients 40, 41, and 42 may also exist within the environment and may represent individual users that access the Web.

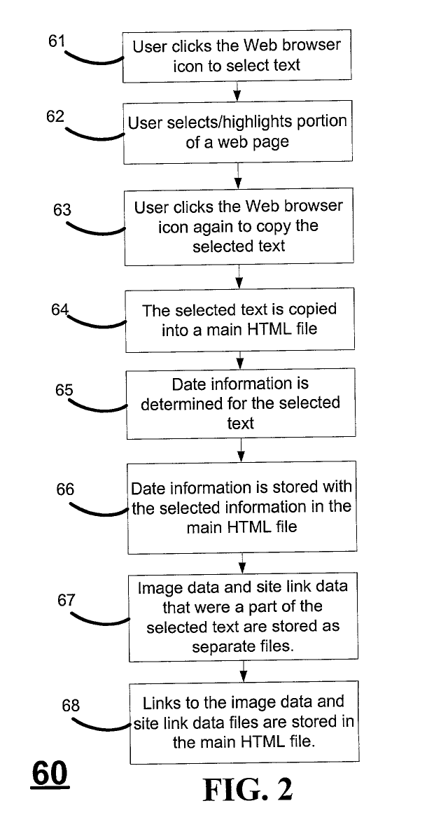

Referring to FIG. 2, one embodiment of a method for saving selected portions of a Web page to a client local storage is generally shown at numeral 60. A user may first click the Web browser icon to select data, shown at 61. Next, the user may select or highlight a portion of the Web page to retain, shown at 62. After the data is selected, the user may click the Web browser icon again to copy the selected data, shown at 63. The text data will be copied into a main HTML file, shown at 64. Date information may then be determined from the Web browser, shown at 65. This date information may be stored with the selected data in the main HTML file, shown at 66. The image data and site link data that may have been part of the selected data from the Web page may be stored as separate files, shown at 67. Links to the image data and site link data files may be stored in the main HTML file, shown at 68.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of saving selected portions of a Web page to a client local storage comprising:
receiving a selection of a portion of the Web page;
storing the selected portion of the Web page to the client local storage;
determining the date information from a Web browser; and
linking the date information to the stored portion of the Web page.

2. The method of claim 1 wherein the portion of the Web page is selected from a group consisting of text data, image data, and site link data.

3. The method of claim 1 wherein storing the selected portion of the Web page comprises saving the selected portion to a main HTML file.

4. The method of claim 3 further comprising storing a second selected portion to the main HTML file.

5. The method of claim 1 wherein the selected portion of the Web page includes image data that is stored in a separate file.

6. The method of claim 5 further comprising linking a main HTML file to the separate image data file.

7. The method of claim 1 wherein the selected portion includes site link data that is stored in a separate file.

8. The method of claim 7 further comprising linking a main HTML file to the separate site link data file.

9. The method of claim 1 further comprising installing an icon on a Web browser.

10. The method of claim 9 further comprising a link to the main HTML file from the icon.

11. A computer usable medium storing a program for saving selected portions of a Web page to a client local storage comprising:
computer readable code for receiving a selection of a portion of the Web page;
computer readable code for storing the selected portion of the Web page to the client local storage;
computer readable code for determining the date information from a Web browser; and
computer readable code for linking the date information to the stored portion of the Web page.

12. The computer usable medium of claim 11 wherein the portion of the Web page is selected from a group consisting of text data, image data, and site link data.

13. The computer usable medium of claim 11 wherein storing the selected portion comprises saving the selected portion to a main HTML file.

14. The computer usable medium of claim 13 further comprising storing a second selected portion to the main HTML file.

15. The computer usable medium of claim 11 wherein the selected portion includes image data that is stored in a separate file.

16. The computer usable medium of claim 15 further comprising linking a main HTML file to the separate image data file.

17. The computer usable medium of claim 11 wherein the selected portion includes site link data that is stored in a separate file.

18. The computer usable medium of claim 17 further comprising linking a main HTML file to the separate site link data file.

19. The computer usable medium of claim 11 further comprising installing an icon on a Web browser.

20. The computer usable medium of claim 17 further comprising linking the icon to the main HTML file.

21. A system for saving selected portions of a Web page to a client local storage comprising:
means for receiving a selection of a portion of the Web page;
means for storing the selected portion of the Web page to the client local storage;
means for determining the date information from a Web browser; and
means for linking the date information to the stored portion of the Web page.
